(19) United States
(12) Patent Application Publication
(10) Pub. No.: US 2008/0236504 A1
(43) Pub. Date: Oct. 2, 2008

(54) PET WASTE COLLECTION PAD

(76) Inventor: Stephen Silverman, Albany, NY (US)

Correspondence Address: HESLIN ROTHENBERG FARLEY & MESITI PC, 5 COLUMBIA CIRCLE, ALBANY, NY, 12203, US

(21) Appl. No.: 11/692,528

(22) Filed: Mar. 28, 2007

(51) Int. Cl. A01K 29/00

(52) U.S. Cl. 119/169

(57) ABSTRACT

A waste collection pad for use in training an animal, such as a domestic pet, to urinate or defecate in a predetermined location. The collection pad includes a support frame and a liquid retaining layer mounted above the support frame. The support frame provides structural rigidity to retain the pad in a flattened state. The collection pad is deformable from a first undeformed shape having a first size to a second deformed shape having a second size, smaller than the first size, for example, a more a convenient shape to facilitate handling. The support frame may comprise a perforated sheet having foldable seams allowing the collection pad to be folded. The collection pad may also be rolled into a cylindrical shape to facilitate handling.

### TECHNICAL FIELD

The present invention relates to pet waste collection pads and methods for using such pads. Specifically, the present invention provides a collapsible pet waste collection pad having a liquid retaining layer mounted to a relatively rigid support frame that retains the pad in a flattened position, for example, without the aid of retaining devices.

### BACKGROUND OF THE INVENTION

Every new pet owner faces the trials of training the new addition to its new environment. Housebreaking a pet, especially, a dog, can be an arduous task and often involves training the pet to urinate and defecate in a single, least offensive location. Many devices have been developed to assist the pet owner in addressing this problem, for example, U.S. Pat. No. 4,949,673 of Yamamoto discloses a pet chamber pot and U.S. Pat. No. 5,355,837 of Reyes discloses a canine toilet station.

One particularly effective device known in the art is the absorbent pad having a liquid impermeable lining that can provide a handy medium for collecting urine and feces while assisting in housebreaking the pet. One popular housebreaking pad is marketed under the name “Wee-Wee Pads” by Four Paws Pet Products.

However, such pads typically inherently are characterized by the disadvantage that, to use them effectively, they must be mounted in a device that will maintain their desired position on the floor. Specifically, such pads are prone to become wrinkled, folded, dislodged, or otherwise disrupted, for example, by the very pet they are intended to train. In response, many devices have been developed to help maintain such pads in their desired flattened state. For example, U.S. Pat. Nos. 6,059,247 of Olivadoti; 6,450,119 of Holt; and 6,550,423 of Pope all disclose some form of rectangular frame adapted to retain a training pad in a flattened state. U.S. Pat. No. 4,715,320 of Barnhart discloses a circular ring for retaining a training pad and U.S. Pat. No. 5,630,376 of Ochi, et al. discloses an absorbent panel having a liquid impermeable back sheet and a raised edge.

However, these and other prior art references require the pet owner to obtain and somehow assemble a structure simply to retain a pet training pad in a desired position, that is, flat on the floor. Clearly, there is a need in the art for a device that obviates the need of assembling such a structure just to effectively use a pet training pad. Aspects of the present invention overcome these and other disadvantages of the existing art.

### SUMMARY OF THE INVENTION

Aspects of the present invention provide a convenient training pad that does not require a structure to maintain a training pad in a desired position, for example, flat on the floor. In addition, aspects of the invention provide a training pad that can be collapsed into a convenient size for storage, shipping, or removal of the soiled pad.

Specifically, one aspect of the invention is an animal waste collection pad, for example, a housebreaking pad or training pad, having a support frame; and a liquid retaining layer mounted above the support frame; wherein the collection pad is deformable from a first undeformed shape having a first size to a second deformed shape having a second size, smaller than the first size. The pad may typically be used for a household pet. The first, undeformed shape may typically comprise the pad spread out on a surface, for example, a floor, where it can be used by the pet. The second, deformed shape typically comprises a shape that is smaller than the first, undeformed shape, for example, when the pad is folded or rolled. According to aspects of the invention, the support frame provides sufficient rigidity whereby the collection pad can be unfurled onto a surface while also being capable of being folded or collapsed for convenient shipping, storage, or disposal. In one aspect, the support frame may be perforated, for example, a perforated cardboard, or paperboard, having a liquid impermeable barrier mounted over the perforated support frame.

Another aspect of the invention is a method of providing a pet waste collection pad comprising or including: mounting a liquid retaining layer to one or more support frames to form a collection pad having a first undeformed shape having a first size; deforming the collection pad to a second deformed shape having a second size smaller than the first size; and inserting the deformed collection pad into a container. Deforming the collection pad may comprise folding the collection pad or rolling the collection pad. In one aspect, the container may comprise a box, bag, or a tube.

These and other aspects, features, and advantages of this invention will become apparent from the following detailed description of the various aspects of the invention taken in conjunction with the accompanying drawings

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention will be readily understood from the following detailed description of aspects of the invention taken in conjunction with the accompanying drawings in which:

FIG. 1 is a perspective view of a pet waste collection pad according to one aspect of the invention.

FIG. 2 is a cross-sectional view of the pet waste collection pad shown in FIG. 1 as viewed along section lines 2-2 in FIG. 1 according to an aspect of the invention.

FIG. 3 is a plan view of the pet waste collection pad shown in FIG. 1 after the pad has been folded according to an aspect of the invention.

FIG. 4 is a plan view of the pet waste collection pad shown in FIG. 1 after the pad has been rolled according to an aspect of the invention.

FIG. 5 is a cross-sectional view of the pet waste collection pad shown in FIG. 1 according to another aspect of the invention.

FIG. 6 is a plan view of another pet waste collection pad according to an aspect of the invention.

FIG. 7 is a plan view of the pet waste collection pad shown in FIG. 6 after the pad has been folded once according to an aspect of the invention.

FIG. 8 is a plan view of the pet waste collection pad shown in FIG. 7 after the pad has been folded twice according to an aspect of the invention.

FIG. 9 is a plan view of a pet waste collection pad according to another aspect of the invention.

FIG. 10 is a plan view of the pet waste collection pad shown in FIG. 9 after the pad has been folded once according to an aspect of the invention.

FIG. 11 is a plan view of the pet waste collection pad shown in FIG. 10 after the pad has been folded twice according to an aspect of the invention.

FIG. 12 is a plan view of the pet waste collection pad shown in FIG. 11 after the pad has been folded three times according to an aspect of the invention.

FIG. 13 is a plan view of a pet waste collection pad according to another aspect of the invention.

FIG. 14 is a plan view of the pet waste collection pad shown in FIG. 13 after the pad has been folded once according to an aspect of the invention.

FIG. 15 is a plan view of the pet waste collection pad shown in FIG. 14 after the pad has been folded twice according to an aspect of the invention.

FIGS. 16, 17, and 18 are plan views of pet waste collection pads according to further aspects of the invention.

FIG. 19 is a perspective view of a folded pet waste collection pad inserted into a container according to an aspect of the invention.

### DETAILED DESCRIPTION

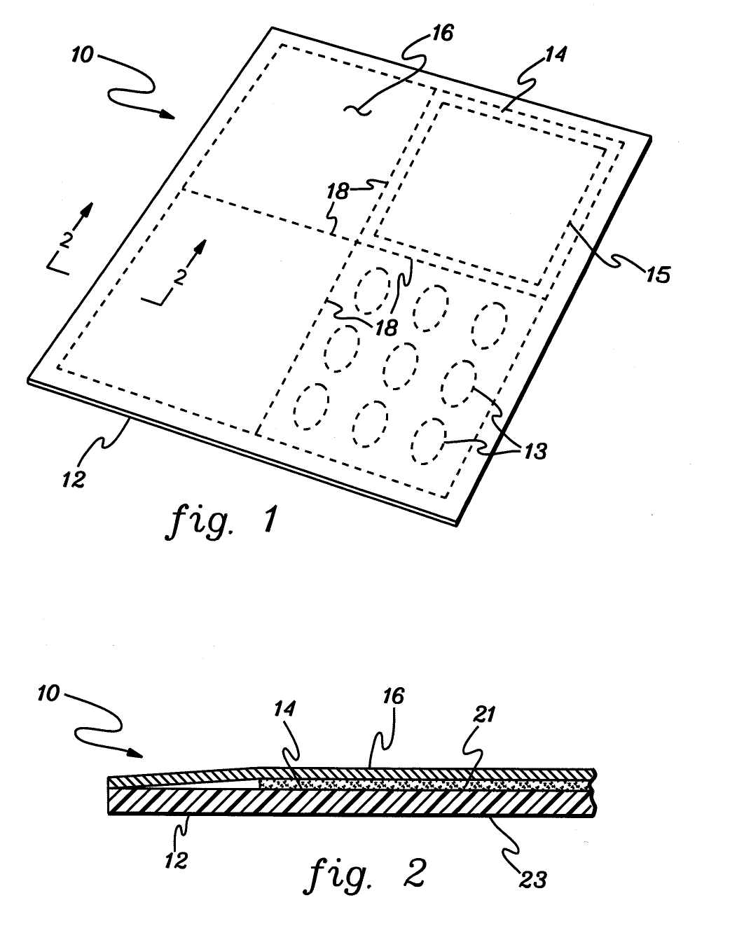

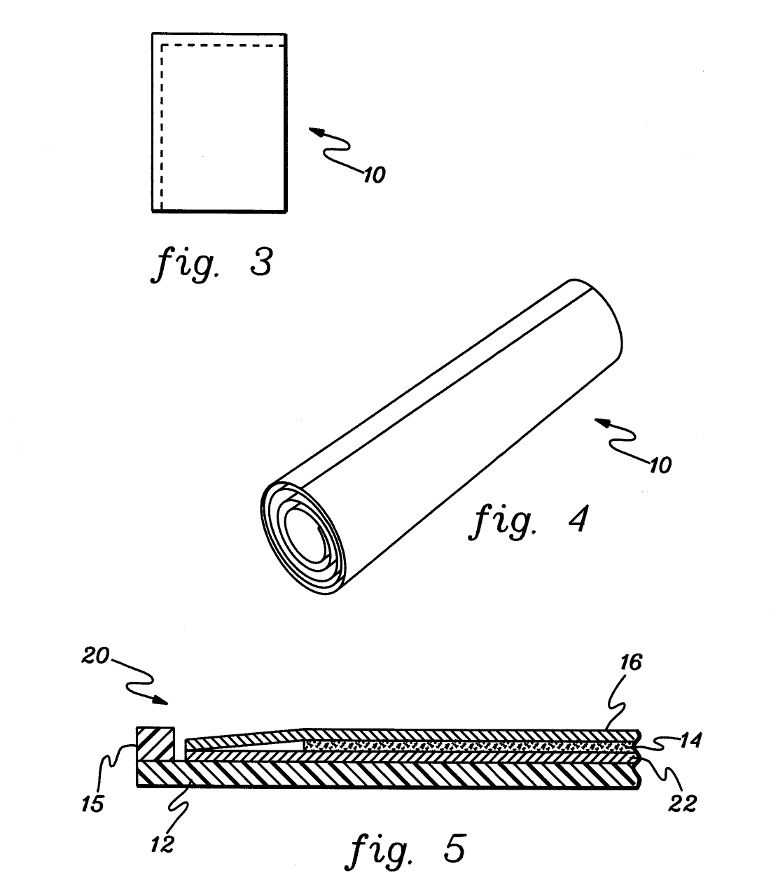

FIG. 1 is a perspective view of a pet waste collection pad 10 according to one aspect of the invention. FIG. 2 is a cross-sectional view of the pet waste collection pad 10 shown in FIG. 1 as viewed through section lines 2-2 in FIG. 1 according to an aspect of the invention. Collection pad 10 includes a support frame 12, for example, a paper board sheet, and a liquid retaining layer 14, for example, a fibrous absorbent layer, mounted above the support frame 12. Collection pad 10 may also include a liquid permeable layer 16, for example, a non-woven cellulose layer, mounted on top of liquid retaining layer 14. In FIG. 1, liquid retaining layer 14 is shown in phantom beneath liquid permeable layer 16. In one aspect, support frame 12 may comprise a substantially uniform sheet or may include a sheet, panel, or frame having one or more perforations, for example, circular perforations 13 or rectangular perforations 15 as shown in phantom in FIG. 1. Perforations 13, 15, and the like may be provided to reduce the weight of support frame 12, and thus reduce the weight of pad 10. According to aspects of the invention, collection pad 10 is deformable from a first undeformed shape having a first size, for example, the undeformed shape shown in FIG. 1, to a second deformed shape having a second size, smaller than the first size, as shown and discussed below with respect to FIGS. 3 and 4.

FIG. 3 is a plan view of the pet waste collection pad 10 shown in FIG. 1 after the pad is folded twice according to an aspect of the invention to form a smaller rectangular shape. FIG. 4 is a perspective view of a collection pad 10 rolled to a smaller cylindrical or tubular shape according to another aspect of the invention. According to aspects of the invention, the smaller shapes of collection pad 10 shown in FIGS. 3 and 4 provide advantages size for storing, shipping, or otherwise handling collection pad 10 before, during, or after use by a pet or other animal.

As shown in FIG. 1, support frame 12 of collection pad 10 may include at least one, but typically, a plurality of, seams or folds 18 (shown in phantom in FIG. 1) about which collection pad 10 may be folded to produce the folded shape shown in FIG. 3. FIGS. 6 through 15 illustrate various sizes, shapes, and sequences of deforming or folding a collection pad, such as, collection pad 10, according to aspects of the invention.

As shown in FIG. 2, liquid retaining layer 14 of collection pad 10 may be sized to be smaller in dimension than support frame 12, though in another aspect of the invention, liquid retaining layer 14 may be co-extensive with or substantially the same size as support frame 12. In other words, support frame 12 may typically be larger than liquid retaining layer 14. As also shown in FIG. 2, liquid permeable layer 16 may typically be sized to substantially cover liquid retaining layer 14, for example, be at least as extensive as, but typically larger in size than liquid retaining layer 14. In one aspect, liquid permeable layer 16 may be co-extensive with or substantially the same size as support frame 12. Liquid permeable layer 16 and liquid retaining layer 14 may be mounted to support frame 12 by conventional means, for example, by means of an adhesive, such as, hot melt glue, or by mechanical fasteners, for example, staples or stitching, and the like.

In one aspect of the invention, liquid retaining layer 14 may be removably mounted to support frame 12, for example, so that liquid retaining layer 14 may be removed from support frame 12 and discarded. The discarded layer 14 may be replaced with another layer 14, for example, a new layer 14, whereby collection pad 10 may be re-used. In other words, in one aspect, support frame 12 may be re-usable, for example, repeatably reusable, and only liquid retaining layer 14 and/or liquid permeable layer 16 replaced as needed. In one aspect, support frame 12 may be washable, for example, by hand or in a dishwasher, and re-used. However, in another aspect of the invention, support frame 12 may not be re-used, for example, when support frame 12 also becomes soiled. Support frame 12 may be discarded or recycled. Liquid retaining layer 14 may be replaceably mounted to support frame 12 by conventional means, for example, by means of an adhesive or hardware, such as snaps or buttons. In another aspect, both liquid retaining layer 14 and liquid permeable layer 16 may be removable and replaceable. In one aspect, liquid retaining layer 14 may be mounted to liquid permeable layer 16, for example, with an adhesive, and liquid permeable layer 16 having liquid retaining layer 14 may be removably mounted to support frame 12 so that both layers 16 and 14 may be removed for disposal and replacement with a new layer 16 and 14, for example, as a prepackaged unit.

Collection pad 10 may include an adhesive adapted to attach pad 10 to a floor. For example, as shown in FIG. 2, collection pad 10 may include a support frame 12 having a first side 21 facing the liquid retaining layer 14, and a second side 23, opposite the first side 21, having an adhesive adapted to removably attach at least a portion of the second side 23 to a surface (not shown), such as, a floor.

Support frame 12 may be liquid permeable or liquid impermeable. For example, liquid permeable support frame 12 may be made from cellulosic material, for example, wood, paper, recycled paper, cardboard, paperboard, recycled paperboard, or cotton. The cellulosic material form which support frame 12 is made may also be treated to provide liquid impermeability, for example, waxed or otherwise coated or impregnated with a non-permeable material. Support frame 12 may also be made from plastic, for example, a molded plastic, for instance, one or more of the plastics listed below. FIG. 5 illustrates a cross sectional view similar to FIG. 2 of a collection pad 20 having a liquid impermeable layer or moisture barrier 22 according to another aspect of the invention. Liquid impermeable layer 22 may be positioned between liquid retaining layer 14 and support frame 12. In this aspect of the invention, support frame 12 may be liquid permeable and liquid impermeable layer 22 limits or prevents the exposure of support frame 12 to liquids. The placement of liquid impermeable layer 22 between liquid retaining layer 14 and support frame 12 may be particularly advantageous when support frame 12 includes perforations.

In one aspect of the invention, collection pads 10 or 20 may have raised edges to minimize leakage of liquid or solids from pad 10. As generally shown as structure 15 in FIG. 5, pad 20 may have a dam or other raised structure 15 adapted to prevent or minimize leakage of liquids or solids from collection pad 10. For example, a separate strip or bar 15 may be mounted to support frame 12 or a ridge or berm 15 may be molded or otherwise formed into support frame 12.

According to one aspect of the invention support frame 12 is made from a material that is more rigid than liquid retaining layer 14, and may also be more rigid than liquid permeable layer 16. According to one aspect of the invention, the rigidity of support frame 12 assists in promoting the flattening of collection pad 10 when collection pad 10 is placed on a flat surface, for example, a kitchen floor or garage, for use by a pet owner. In contrast to the devices that typify the prior art, aspects of the invention provide a collection pad 10 that includes a means for retaining the absorbent layer 14 in a substantially flat and extended shape, that is, a shape in which collection pad 10 can better serve its desired function, for example, collection of pet waste. However, according to aspects of the invention, collection pad 10 is also deformable, for example, collapsible, foldable, or rollable, whereby collection pad 10 can be more easily packaged for storage or shipping or readily collapsible for disposal or re-use.

In one aspect, support frame 12 may be made from cardboard or particle board, for example, virgin, recycled, or post-consumer waste cardboard or particle board. Support frame 12 may be made from a plastic, for instance a liquid impermeable plastic. For example, support frame 12 may be made from one or more of the following plastics: a polyamide (PA), for example, nylon; a polyamide-imide; a polyethylene (PE); a polypropylene (PP); a polyester (PE); a polytetraflouroethylene (PTFE); an acrylonitrile butadiene styrene (ABS); a polycarbonate (PC); or a vinyl, such as, polyvinylchloride (PVC), among other plastics. Support frame 12 may also be elastomeric, for example made from one or more of the following elastomeric materials: a natural rubber; a neoprene; a chloroprene; an ethylene-propylene rubber (EDM/EPDM); a urethane, for example, a polyurethane; styrene-butadiene rubber (SBR); isoprene rubber (IR); butadiene rubber (BR); a silicone rubber, for example, a room-temperature vulcanizing (RTV) silicone rubber; and other synthetic rubber or compounds. Support frame 12 may also be metallic, for example, made from aluminum or steel. Support frame may also be made from a permeable material, such as cardboard, that is treated to make the permeable material substantially impermeable. For example, a permeable medium may be treated with wax or plastic, for example, to provide a wax or plastic coated frame or wax or plastic impregnated frame. Liquid impermeable layer 22 may also be made from one or more of the above plastics, elastomers, or metals, for example, a thin film polyethylene or polypropylene.

Liquid retaining layer 14 may be made from any material adapted to retain liquid, in particular, to retain bodily fluids such as pet urine. Layer 14 may be cellulosic, for example, made from wood or cotton fibers, for non-cellulosic, for example, made from a fibrous plastic, such as fiberglass or water-absorbing polymers, such as polyacrylamide, in a fashion similar to those used in diapers. Layer 14 may also include one or more hydrogels, for example, a hydrogel made from a natural or synthetic polymer.

Liquid permeable layer 16 may be made from any material adapted to allow a liquid to pass through or to transmit a liquid when exposed to a liquid, for example, when exposed to pet urine. In one aspect, layer 16 may provide a surface that is soft or comfortable to the pet sitting or lying on layer 16. Layer 16 may be non-abrasive, hydrophilic, or non-absorbing. Layer 16 may also provide some form of “wicking” properties, that is, layer 16 may be made from a material adapted to draw liquid from its exposed surface through layer 16 and into the liquid retaining layer 14, for example, whereby the exposed surface of layer 16 may feel substantially dry to the touch.

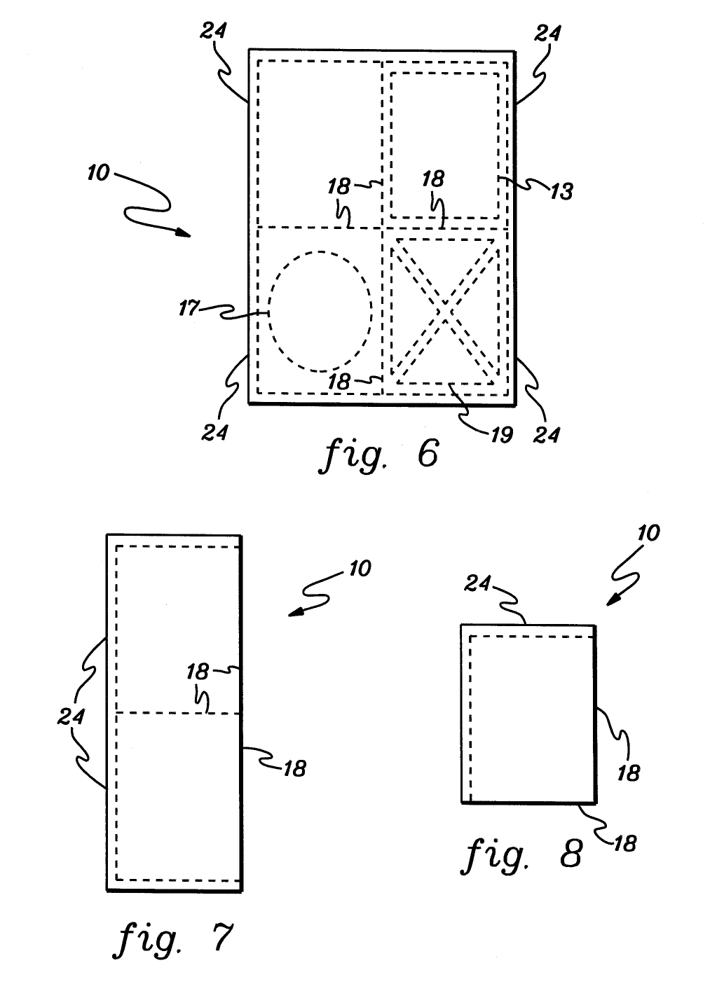

FIGS. 6, 7, and 8 illustrate one sequence of deforming collection pad 10 according to one aspect of the invention. FIG. 6 is a plan view of another pet waste collection pad 10 similar to pad 10 shown in FIG. 1. FIG. 7 is a plan view of collection pad 10 shown in FIG. 6 after collection pad 10 has been folded once about a seam 18 according to an aspect of the invention. FIG. 8 is a plan view of collection pad 10 shown in FIG. 7 after collection pad 10 has been folded again about a seam 18 according to an aspect of the invention. As shown in FIGS. 6, 7, and 8, support frame 12 may typically comprises a plurality of panels 24 and the deformed shape may comprises at least one panel 24 folded upon an adjacent panel 24, as shown in FIG. 7. As shown in FIGS. 6, 7, and 8, at least one panel 24 may include at least one common edge pivotally mounted to adjacent panel 24, for example, at seam 18. In addition to being a pliable seam 18 in support frame 12, the at least one common edge may be a fold in the support frame 12 or the at least one common edge may be a separation or break between panels 24 that is bridged by the liquid retaining layer 14, the liquid permeable layer 16, the liquid impermeable layer 22, or a combination thereof, to form a rudimentary hinge between adjacent panels 24. FIG. 6 also illustrates further typical perforations that may be provided in support frame 12, for example, one or more rectangular perforations 13 (shown in phantom), one or more circular perforations 17 (shown in phantom), or one or more triangular perforations 19 (shown in phantom).

Clearly, pad 10 shown in FIG. 8 is smaller in size, or smaller in extent, than the size of collection pad 10 shown in FIG. 6. According to aspects of the invention, collection pad 10 may be folded at least once, for example, at least once about seam 18, though for larger size pads 10, a plurality of folds may typically be necessary to provide the deformed shape of reduced size that is typical of the folded pad 10 shown in FIG. 8. In one aspect of the invention, the resulting deformed size of pad 10 need only be smaller in extents than pad 10 in its undeformed state.

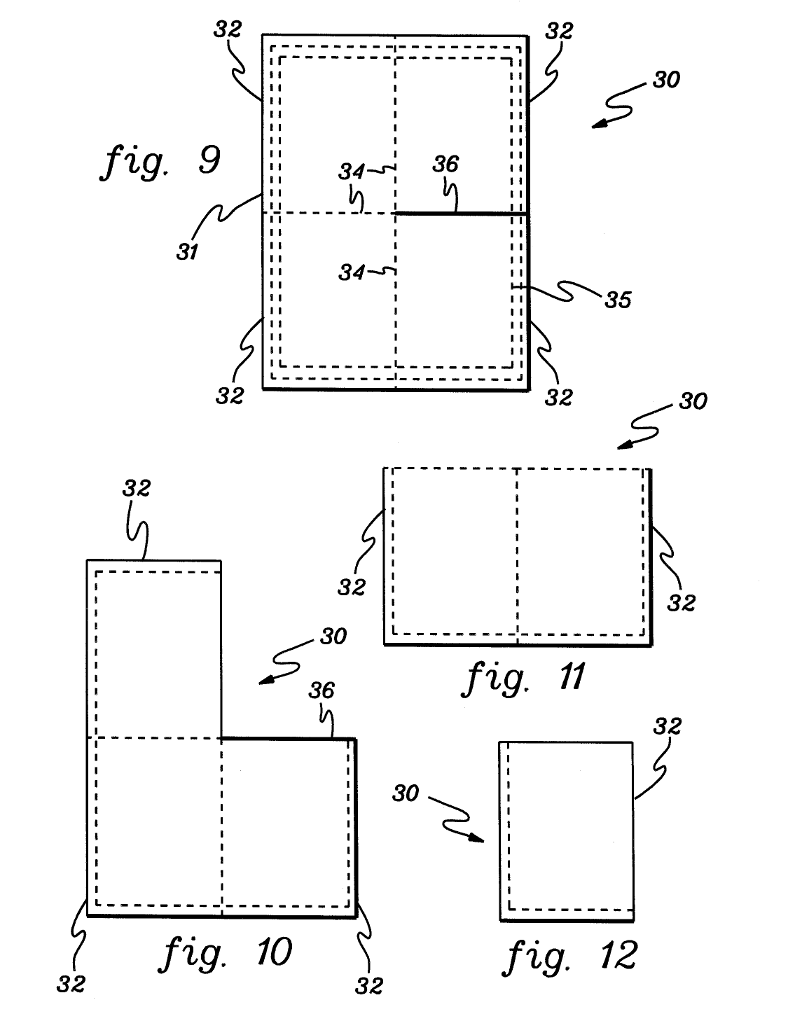

FIGS. 9, 10, 11, and 12 illustrate another sequence of deforming or folding collection pad 10 according to another aspect of the invention. FIG. 9 is a plan view of a pet waste collection pad 30, similar to pads 10 and 20, according to another aspect of the invention. Similar to pads 10 and 20, pad 30 may comprise a support frame 31 (having all the attributes of support frame 12) and a liquid retaining layer 33 (having all the attributes of liquid retaining layer 14). In the aspect shown in FIG. 9, support frame 31 includes a plurality of panels 32 and one or more seams 34, but also includes at least one separation 36, that is, a break or division in the corresponding support frame 31 and liquid retaining layer 33. In contrast to the folding sequence shown in FIGS. 6, 7, and 8, collection pad 30 may also be folded as illustrated in FIGS. 10, 11 and 12. FIG. 10 is a plan view of the collection pad 30 shown in FIG. 9 after panel 32 is folded once about seam 34 according to an aspect of the invention. FIG. 11 is a plan view of collection pad 30 shown in FIG. 10 after a further panel 32 is folded about a seam 34, and FIG. 12 is a plan view of collection pad 30 shown in FIG. 11 after pad 30 is further folded about a seam 34. Again, clearly, pad 30 shown in FIG. 12 is smaller in size, or smaller in extent, than the size or extent of collection pad 30 shown in FIG. 9. FIG. 9 also illustrates further typical perforations that may be provided in support frame 31, for example, one or more rectangular perforations 35 (shown in phantom). According to one aspect, since separation 36 may provide an undesirable leakage path, pad 30 may include a liquid impermeable layer that bridges separation 36, for example, employing an adhesive.

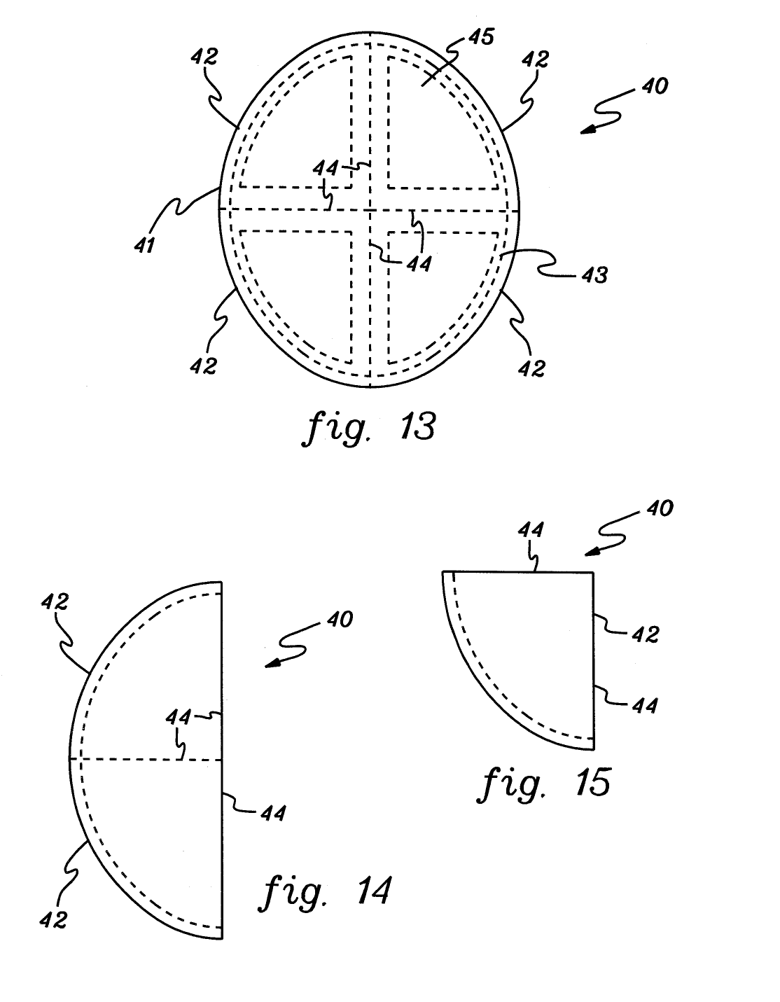

FIGS. 13, 14, and 15 are plan views illustrating another sequence of deforming or folding a circular pet waste collection pad 40 according to further aspects of the invention. Similar to pads 10, 20, and 30, pad 40 may comprise a support frame 41 (having all the attributes of support frame 12) and a liquid retaining layer 43 (having all the attributes of liquid retaining layer 14). In the aspect shown in FIG. 13, support frame 41 includes a plurality of panels 42 and one or more seams, separations, or breaks, 44 and may be folded as illustrated. FIG. 13 also illustrates further typical perforations that may be provided in support frame 41, for example, one or more sector-shaped perforations 45 (shown in phantom).

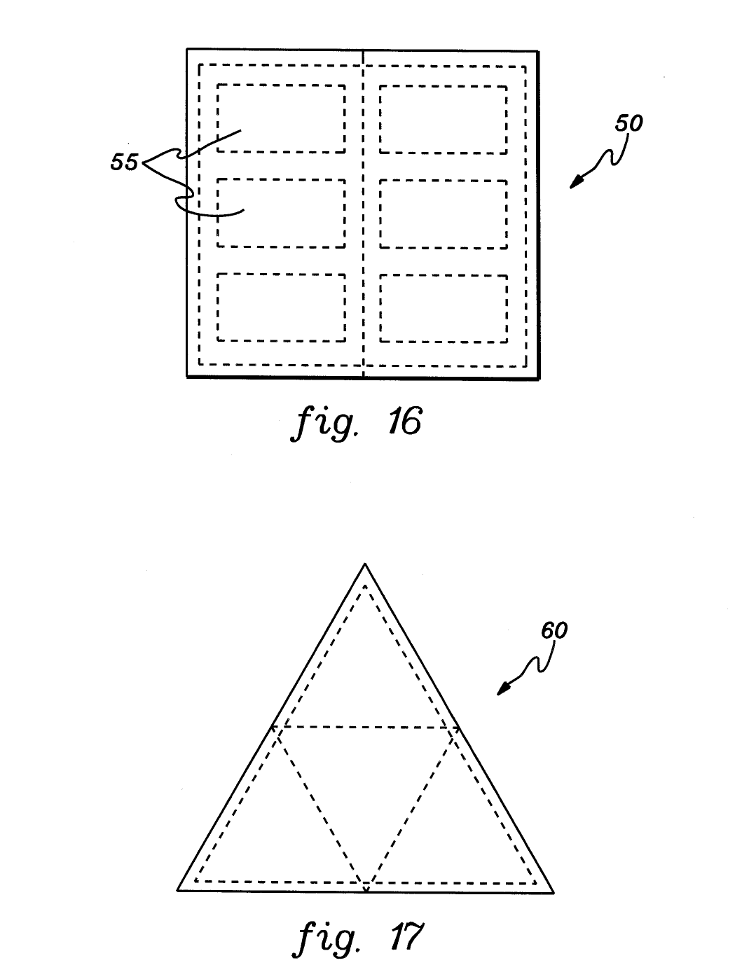

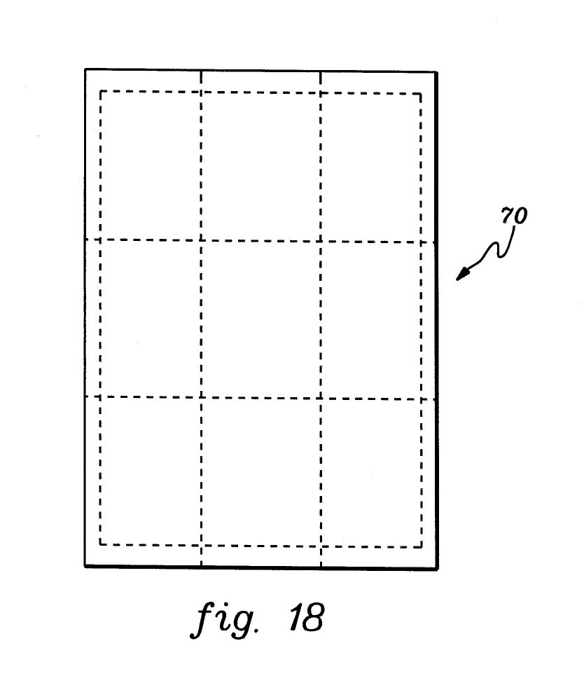

FIGS. 16, 17, and 18 are plan views of further collection pads 50, 60, and 70, respectively, having various shapes and sizes according to other aspects of the invention. FIG. 16 also illustrates further typical perforations that may be provided in support frame 12, for example, one or more rectangular perforations 55 (shown in phantom).

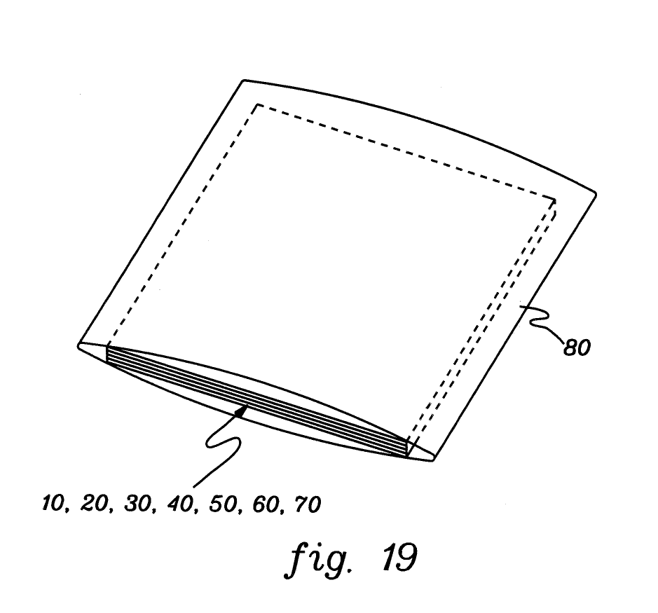

FIG. 19 is a perspective view of the folded pad 10 shown in FIG. 8, pad 20 in FIG. 5, pad 30 shown in FIG. 12, pad 40, pad 50, pad 60, or pad 70 when inserted into a container 80, for example, a bag, according to an aspect of the invention. Container 80 may be any suitable container, for example, a box, bag, or tube, and may be made from any conventional material, for example, paper, cardboard, paperboard, or plastic. According to aspects of the invention, pad 10, 20, 30, 50, 50, 60, or 70 may be stored in container 80 for storage or shipping and then may be removed from container 80 and, with the aid of support frame 12, 31, 41, or others, laid out on a surface for use by a pet. However, contrary to the prior art, no separate retaining devices or frames are required to retain pad 10, 20, 30, 40, 50, 60, and 70 in a flattened position. Container 80 may also be used to dispose of the soiled pad, or for disposal of the soiled liquid retaining layer.

In one aspect of the invention, collection pads 10, 20, 30, 40, 50, 60, and 70 may be adapted to attach to one or more similar pads, for example, to provide a larger area of coverage, for instance for larger animals, such as, large dogs, horses, or cattle. For example, an adhesive may be applied to the top or bottom peripheral edges of support frame 12 to promote adhesion of one support frame 12 of a first pad 10 to a second support frame 12 of another, second pad 10. The adhesive applied to support frame 12 may be provided in a thin strip of adhesive that may be protected by a removable plastic strip. The plastic strip on either the top or bottom of support frame 12 can be removed when attaching the pad to another pad. In another aspect, layer 16 or layer 22 may be provided larger than support frame 12, for example, about an inch larger on at least one side, and be provided with an adhesive or hardware whereby the portion of the larger layer 16 or 22 that extends beyond support frame 12 may be mounted to an adjacent support frame 12. In one aspect, the portion of layer 16 or layer 22 that extends beyond support frame 12 may be attached to the underside of support frame 12, for example, by means of an adhesive or hardware, to retain the excess material until needed.

In one aspect, collection pads 10, 20, 30, 40, 50, 60, and 70 may be provided with an appropriate attractant to encourage an animal to use the collection pad, for example, an odor or scent that attracts an animal.

Thus, it is clear that aspects of the present invention provide pet waste collection pads, housebreaking pads, or training pads that are not found in the prior. Contrary to aspects of the prior art, no additional support structures or devices need be provided to effectively retain a pet waste collection pad in the desired flattened state. Aspects of the invention provide a collection pad having its own support frame for retaining the collection pad in a flattened state while permitting the pad to be folded or collapsed to facilitate storage, shipping, and other handling. Aspects of the invention may be used for domestic pets, such as dogs, cats, reptiles, rodents, birds, and the like, but other aspects of the invention may be used for larger animals, such as barn yard animals, for example, horses, cows, sheep, etc. Aspects of the invention may be used for large and small animals in veterinary clinics or hospitals. Though aspects of the invention can be used for pet training purposes, aspects of the invention may also be as a primary means for collecting pet urine or feces, for example, for older or disabled dogs, for which “walking” is not feasible, for instance, for use by older dogs whose owners live in high-rise apartments.

Though aspects of the invention may be characterized as pads that are deformable to a smaller size, for example, for handling or storage, in one aspect, the pad may not be readily deformable. For example, in one aspect, the support frame 12 may provide a rigid structure, for instance, a relatively rigid sheet, that retains the liquid retaining layer 14 in a flattened state. In this aspect, no deformation, such as, folding or rolling, may be necessary. For example, pad 10 may be relatively small and not require folding or rolling to be handled or stored, for example, in a bag, or pad 10 may be provided in the form of an undeformed larger sheet having a relatively rigid, perforated or unperforated, support frame 12.

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

1. An animal waste collection pad comprising:
a support frame; and
a liquid retaining layer mounted above the support frame;
wherein the collection pad is deformable from a first undeformed shape having a first size to a second deformed shape having a second size, smaller than the first size.

2. The collection pad as recited in claim 1, wherein the support frame comprises a plurality of panels and wherein the second deformed shape comprises at least one panel folded upon an adjacent panel.

3. The collection pad as recited in claim 2, wherein the at least one panel comprises at least one common edge pivotally mounted to the adjacent panel.

4. The collection pad as recited in claim 3, wherein the at least one common edge pivotally mounted to the adjacent panel comprises a fold in the support frame.

5. The collection pad as recited in claim 1, wherein the collection pad is adapted to be rolled wherein the second deformed shape comprises a cylindrical shape.

6. The collection pad as recited in claim 1, wherein the pad further comprises a liquid impermeable barrier.

7. The collection pad as recited in claim 6, wherein the liquid impermeable barrier is positioned between the liquid retaining layer and the support frame.

8. The collection pad as recited in claim 1, wherein the support frame comprises a frame having a rigidity greater than a rigidity of the liquid retaining layer.

9. The collection pad as recited in claim 1, wherein the collection pad further comprises a liquid permeable layer.

10. The collection pad as recited in claim 9, wherein the liquid permeable layer is positioned over the liquid retaining layer.

11. The collection pad as recited in claim 1, wherein the support frame comprises a plurality of perforations.

12. The collection pad as recited in claim 1, wherein the a support frame comprises a first side facing the liquid retaining layer and a second side, opposite the first side, the second side having an adhesive adapted to removably attach at least a portion of the second side to a surface.

13. The collection pad as recited in claim 1, wherein the support frame is larger than the liquid retaining layer.

14. The collection pad as recited in claim 1, wherein the liquid retaining layer is removably mounted to the support frame.

15. The collection pad as recited in claim 3, wherein the at least one common edge pivotally mounted to an adjacent panel comprises a separation bridged by the liquid retaining layer.

16. A method of providing pet waste collection pad comprising:
mounting a liquid retaining layer to one or more support frames to form a collection pad having a first undeformed shape having a first size;
deforming the collection pad to a second deformed shape having a second size smaller than the first size; and
inserting the deformed collection pad into a container.

17. The method as recited in claim 16, wherein deforming the collection pad comprises folding the collection pad.

18. The method as recited in claim 16, wherein deforming the collection pad comprises rolling the collection pad.

19. The method as recited in claim 16, wherein mounting the liquid retaining layer to the one or more support frames comprises mounting the liquid retaining layer having a first surface area to one or more support frames having a second surface area greater than the first surface area.

20. The method as recited in claim 16, wherein the container comprises a plastic bag.

21. The collection pad as recited in claim 1, wherein the collection pad is adapted to be mounted to another collection pad.

22. The collection pad as recited in claim 6, wherein the liquid impermeable layer is removably mounted to the support frame.

23. The collection pad as recited in claim 9, wherein the liquid permeable layer is removably mounted to the support frame.
